(19) United States
(12) Patent Application Publication
(10) Pub. No.: US 2018/0005268 A1
(43) Pub. Date: Jan. 4, 2018

(54) SHOPPING AND MARKETING METHOD OF AN ITEM FOR SPECIFIC CONSUMERS

(71) Applicant: PORTWELL INC., NEW TAIPEI CITY (TW)

(72) Inventor: KUANG HUNG CHENG, NEW TAIPEI CITY (TW)

(21) Appl. No.: 15/631,914

(22) Filed: Jun. 23, 2017

(30) Foreign Application Priority Data
Jul. 4, 2016 (TW) 105121111

(51) Int. Cl. G06Q 30/02; G06Q 20/32; H04L 29/08; G06Q 30/06; G06Q 30/00

(52) U.S. Cl. CPC G06Q 30/0261; H04L 67/18; G06Q 30/0641; G06Q 30/0633; G06Q 20/322; G06Q 30/0601; G06Q 30/0268; G06Q 30/0619; G06Q 30/00

(57) ABSTRACT

A shopping and marketing method of an item for specific consumers includes: installing a networking module having an induction chip with item ID onto an item body; (2) sensing the item by a mobile device connected to a marketing website and transmitting the item ID to the marketing website; (3) verifying the item ID by the marketing website; and (4) connecting to a marketing webpage of a corresponding group if the item ID is matched. Therefore, the item ID of the item is provided for logging on a specific website to achieve the marketing method by transmitting a specific corresponding message to specific consumers.

### FIELD OF THE INVENTION

The present invention relates to an item sensing and displaying system, and more particularly to a shopping and marketing method of an item for specific consumers, and the method is capable of selecting and categorizing specific groups by using an item ID as a medium to achieve the effect of transmitting and displaying different corresponding messages.

### BACKGROUND OF THE INVENTION

### 1. Description of the Related Art

As networking technology advances, a network used for exhibiting, or selling/buying a product (such as those in online shopping) becomes a feature of present shopping and purchasing. Manufacturers usually set up a website to exhibit and promote their products, and consumers may use a camera of a smart phone to scan a quick response (QR) code of a document or an item tag in order to connect to a specific website and obtain related information. However, anyone can logon a network to browse an item from a manufacturer's website conveniently, so that the website no longer has its specificity, and specific customers do not have the honor and privacy of browsing specific products, and that is exactly the difficulty for a commercial website to create its specific style. On the other hand, some vendors selling specific products have difficulty to control the information of certain kinds of products by the present online shopping information broadcasting method for potential customers of high level of consumption, and such information attracts the attention of the consumers of specific levels. In addition, it is difficult to transmit the information of specific products to old or potential customers of specific levels timely. Therefore, related manufacturers and sellers have to break through the aforementioned bottleneck and search for a feasible solution.

Based on the factors such as the quality and type of the related product and the security of network transaction, particularly for high-priced products or special products requiring personal selections, physical stores are needed for checking and selecting the product at spot, so that physical store is still one of the primary methods of selling/buying the products of this sort. Since the type and quantity of the products exhibited in the physical stores are restricted by space and the products may be damaged or worn out after the exhibition (similar to the case of a sample), the exhibition of products in physical stores is obviously not the best way of selling the high-priced products. On the contrary, the exhibition via network is a better choice. For example, if an old customer or a potential customer of the product of this level shows up, related information of the desired product can be transmitted timely for the buyer's checking and selection. After the buyer has decided to buy, the selected product may be taken out for the buyer's purchase or order, so as to save the exhibition space, and avoid damages of the product during the exhibition, or even provide customers a certain level of honor and promote immediate sales. The present invention not just overcomes the aforementioned drawbacks of network marketing and physical store exhibition only, but also combines network information with the physical store to create an excellent marketing method.

As technology advances, the near field communication (NFC) technology is applied for data transmission between existing electronic devices such as IC card (including credit cards), IPASS, access control, and tickets. Since the near field communication (NFC) technology uses the RF domain of a contact card reader for power supply, therefore the operation will be continued even when the card has no power. If the near field communication (NFC) technology is combined with the item exhibition through network marketing and physical store, and a portable electronic device (such as a mobile phone, a Tablet PC, or a smart wearable device, etc) is used for receiving and displaying information, the effect of timely displaying the marketing information for customers of the corresponding level can be achieved.

In view of the drawbacks of the prior art, the inventor of the present invention conducted extensive research and finally provided a shopping and marketing method of an item for specific consumers in accordance with the present invention, and the feasible method of the invention has the features of precise target and high uniqueness.

### 2. Summary of the Invention

Therefore, it is a primary objective of the present invention to use a desired item as a medium to logon an account of a website by an item ID in order to connect both buyers and sellers at a spot and display the marketing information timely to achieve the effects of marketing, exhibiting and selling a product.

Another objective of the present invention is to provide a communication link selling method with the features of high uniqueness and effectiveness, and the method uses feedback information of a sensed item to determine the level of the sensed item or the specific consumer group, and transmit the product information timely for the purchaser's reference.

A further objective of the present invention is to provide a purchasing and marketing method with a sale assisting effect of a physical selling of a specific or non-general item, and the method is combined with a network to timely display related marketing information to compensate the deficiency of marketing in the physical stores, so as to provide a network marketing with the features of precise target and high honor.

Another objective of the present invention is to provide a purchasing and marketing method that installs a networking module having a predetermined special ID onto a product (or an item body), and the special ID allows a buyer and a seller to have a network connection and message transmission channel, so that the buyer can sense the product and the seller can transmit the related network marketing information of the desired product timely.

To achieve the aforementioned and other objectives, the present invention provides a shopping and marketing method of an item for a specific consumer, and the method comprises the steps of: (1) installing a networking module having an induction chip with at least one item ID onto an item body; (2) sensing the item by a mobile device connected to a marketing website, and transmitting the item ID to the marketing website; (3) verifying the item ID after the marketing website receives the item ID; and (4) connecting to a marketing webpage of a corresponding group if the item ID is matched, and displaying the content and information of the marketing webpage on a display unit of the mobile device via a network.

The method further comprises: a step of setting at least one specific consumer group, and connecting and displaying the corresponding marketing webpage of the specific consumer group if the item ID is matched.

In the aforementioned method, the specific consumer group is categorized or selected according to the set item by a computer automatically.

In the aforementioned method, the Step (3) automatically determines and verifies the item ID by the verifying content installed in a verification unit.

In the aforementioned method, if the item ID is not matched with the specific consumer groups after verification, the display unit of the mobile device will not display any content or information.

In the aforementioned method, the networking module is an electronic tag, NFC tag, or an assembly capable of performing an inductive networking, and the networking module further includes an induction coil.

In the aforementioned method, the item body is an item of a product, a card or a tag.

In the aforementioned method, the mobile device is a smart phone, a Tablet PC or a smart wearable device, and the mobile device includes a display unit, a control unit, an NFC reading unit, an input/output unit and a communication unit.

In the aforementioned method, the verification unit has a verifying content for determining and verifying the verifying content of the item ID.

In the aforementioned method, the marketing website is a cloud server.

The above and other objects, features and advantages of this disclosure will become apparent from the following detailed description taken with the accompanying drawings.

### BRIEF DESCRIPTION OF THE DRAWINGS

FIG. 1 is a schematic view of the present invention;

FIG. 2 is an operation flow chart of the present invention; and

FIG. 3 is a schematic view of a sensing operation of the present invention.

### DESCRIPTION OF THE PREFERRED EMBODIMENTS

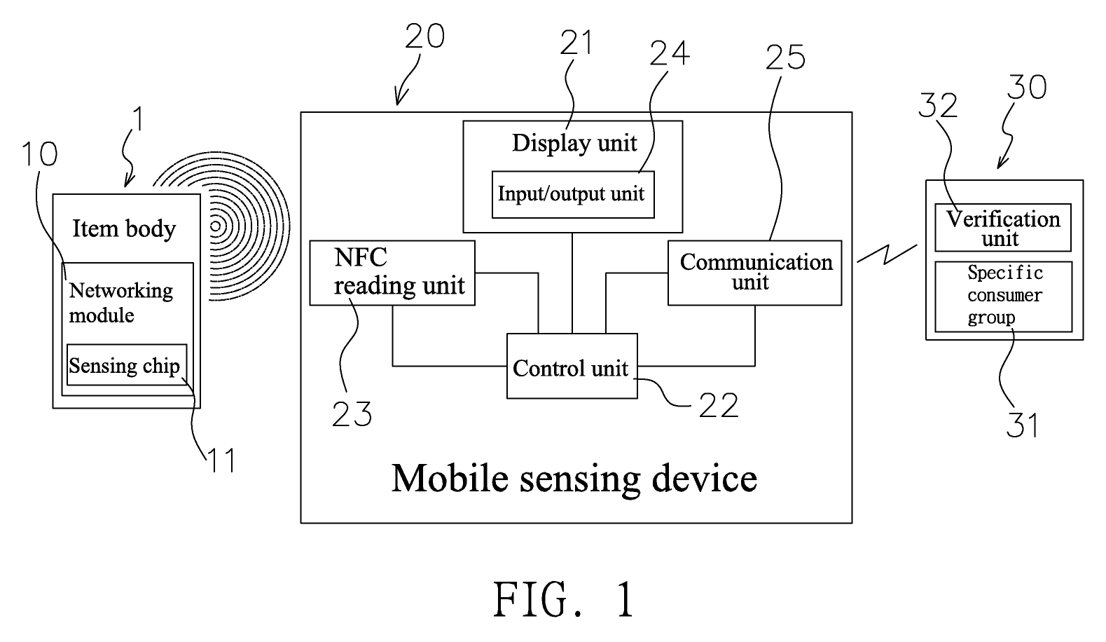

With reference to FIG. 1 for a schematic view illustrating a shopping and marketing method of an item for specific consumers of the present invention, it is noteworthy that the figure is intended for the purpose of illustrating the basic structure of the invention, and not necessarily drawn according to the actual size, shape or proportion. In FIG. 1, a target product sensing, transmitting and displaying device comprises an item body 1 having a networking module 10 which is an electronic tag, an NFC tag, or any other assembly of performing a inductive networking, and the networking module 10 comprises a combination of an induction chip 11 and an induction coil (not shown in the figure) such as an NFC chip and an NFC coil. The networking module 10 may be in form of a sheet directly embedded/attached/sewed on the item body 1, or in form of a label or a tag combined onto the item body 1. The item body 1 is generally a product. In other embodiments, the item body 1 may be an item containing the networking module 10 such as a card or a tag.

In addition, the induction chip 11 comprises the following components:

At least one item ID which is a group code representing or distinguishing a group of consumer targets related to the item and installed in the inductive chip 11. In an appropriate implementation, the item ID may be set according to the price of the item, such as four item price groups, respectively: 100,000˜200,000 dollars, 200,000˜500,000 dollars, 500,000˜1,000,000 dollars, and 1,000,000 or above, and each of the item price groups has its own group code, which can be determined and categorized according to a set item and a level by a computer to form item IDs of different levels. The item ID may be set according to a group only, such as the item price group of over 1,000,000 depending on a desired consumer group set by the setter. Of course, the item ID may be set according to other items (such as the type and property of an item), and the invention is not limited to the type of the item.

A mobile device 20 may be a smart phone, a Tablet PC, or a smart wearable device acting as a sensing device for sensing the networking module 10 (with the induction chip 11) to achieve the sensing and transmitting effects. The mobile device 20 comprises a display unit 21, a control unit 22, an NFC reading unit 23, an input/output unit 24, and a communication unit 25, wherein the display unit 21, the NFC reading unit 23, the input/output unit 24 and the communication unit 25 are electrically coupled to the control unit 22; the display unit 21 may be a touch screen; and the communication unit 25 may be a mobile networking module, a WiFi module or a mobile networking module such as 3G or 4G networking module, etc.

A marketing website 30 is connected for transmissions between the marketing website 30 and the mobile device 20 via wireless, and the marketing website 30 has at least one specific consumer group 31 and a verification unit 32; and the specific consumer groups 31 is a target or desired target group. For example, the specific consumer group 31 may be categorized or selected according to the old customer groups, and determined and categorized according to the set purchase price level by a computer to form one or more specific consumer groups 31. The specific consumer group 31 is corresponsive to a marketing webpage of a corresponsive level group, and the marketing webpage of the group can exhibit products of different levels corresponsive to different specific consumer groups 31. If the specific consumer group 31 is matched, the marketing webpage of the group is connected for transmission. The verification unit 32 has the verifying content to determine and verify the specific consumer group 31 (including but not limited to a mobile phone number, a mobile phone code, or a code provided by manufacturers). In addition, the marketing website 30 may be a cloud server.

When the target product inductive sensing, transmitting and displaying device of the present invention is used and the mobile device 20 (such as a mobile phone) senses the networking module 10 (with the induction chip 11) of the item body 1, the NFC reading unit 23 of the mobile device 20 senses the networking module 10 (with the induction chip 11) and is communicatively connected to the marketing website 30 (or cloud server) set by the networking module 10. Now, the item ID in the induction chip 11 is transmitted to the marketing website 30 and determined and verified to be a specific consumer group 31 by the verification unit 32, so that a marketing webpage of a group corresponsive to level of the specific consumer group 31 is connected and transmitted and finally displayed on a display unit 21 (or a touch screen) of the mobile device 20, so that the browsing and purchasing activities of the products exhibited in the webpage can be performed. When a buyer is located at a physical store, the buyer also may request to look at the physical product which is exhibited in the webpage to compensate the issue of unable to fully exhibit the product as well as the physical store and facilitate the trading timely. In other words, a user needs the item ID of the item to logon an account of the marketing website 30 (or a specific website), and the user cannot logon or use the content of the marketing website 30 by applying an account password.

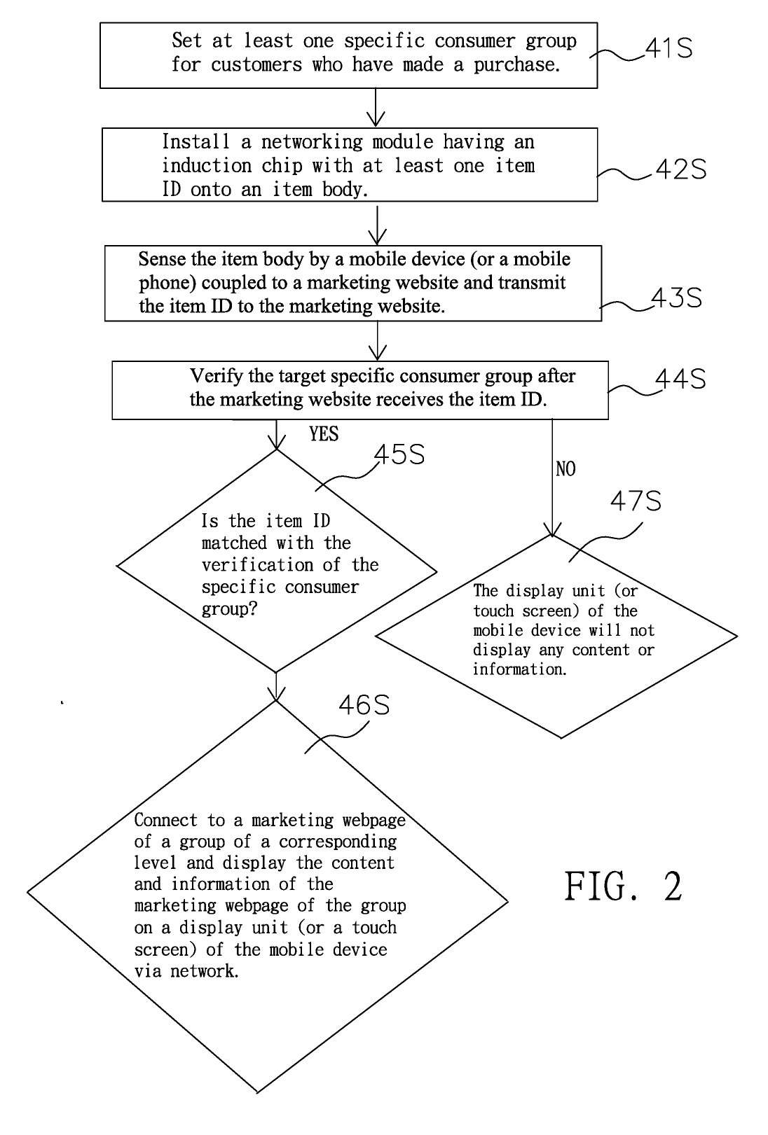

With reference to FIG. 2 altogether, the shopping and marketing method of an item for specific consumers of the present invention further includes the step of:

(1) setting at least one specific consumer group for customers who have made a purchase, and this step can be completed by categorizing or selecting a group according to a set purchase price automatically by a computer, and the specific consumer groups 31 are stored in a marketing website 30 (or a cloud server) (41S).

(2) installing a networking module having an induction chip with at least one item ID onto an item body (42S);

(3) sensing the item body by a mobile device (or a mobile phone) coupled to a marketing website, and transmitting the item ID to the marketing website (43S);

(4) verifying the target specific consumer group after the marketing website receives the item ID (44S), and determining and verifying the item ID automatically by the verifying content installed in the verification unit 32; and

(5) if the item ID is matched with the verification of the specific consumer group (45S), then (6) connecting to a marketing webpage of a group of a corresponding level and displaying the content and information of the marketing webpage of the group on a display unit (or a touch screen) of the mobile device via network (46S); and if the item ID is not matched with the verification of the specific consumer groups, then (7) the display unit (or touch screen) of the mobile device will not display any content or information (47S).

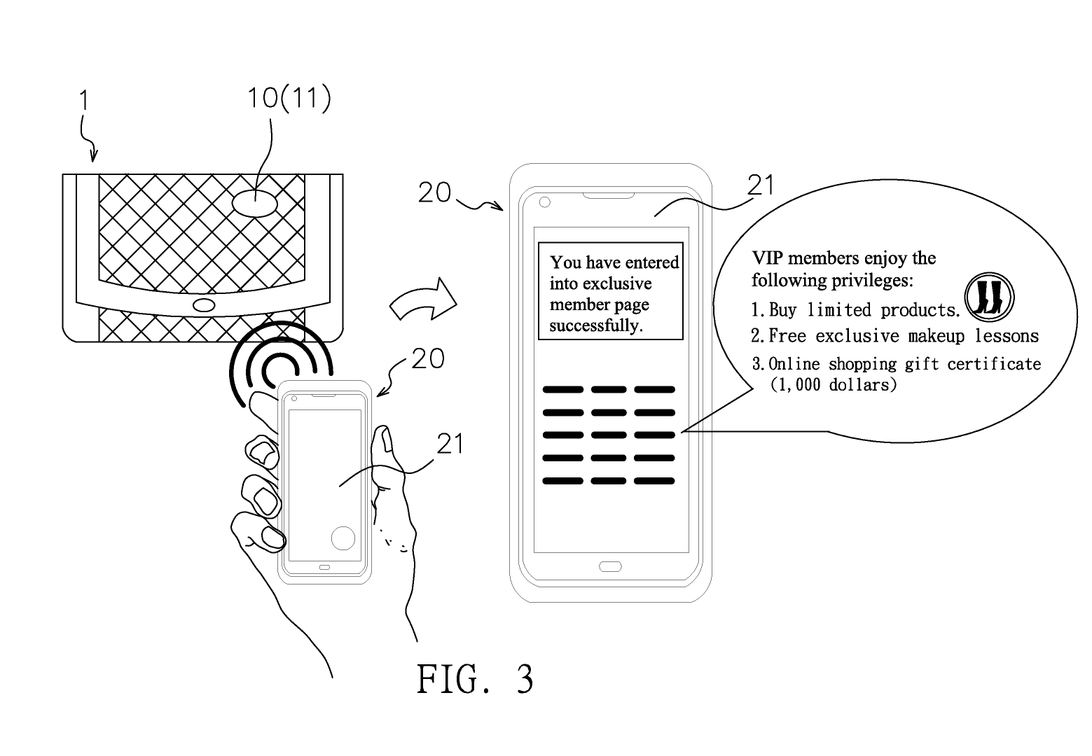

With reference to FIG. 3 altogether, when a purchaser wants to purchase a product (or an item body 1) having the networking module 10, the purchaser may use the mobile phone (or mobile device 20) to sense the product and complete the logon by the transmitted item ID and related information and is included into a specific consumer group 31, and it is one of the methods of forming the specific consumer group 31, and the display unit 21 (or touch screen) of the purchaser's mobile phone will display the marketing webpage of the group of the corresponsive level. Since the product already has the networking module 10, the purchaser and the manufacturer have maintained a medium for communications all the time. When the purchaser further senses the product by the mobile phone again, the most updated content of the marketing webpage of the group will be displayed, so that the purchaser can receive the most updated related marketing information.

In the shopping and marketing method of an item for specific consumers of the present invention, the aforementioned assembly can use a desired item as a medium to perform a network connection between the buyer and seller at the spot timely, and the marketing information can be displayed timely to achieve the effect of marketing, exhibiting, and selling the product. In the meantime, the present invention determines the level of the sensed item by the feedback information or determines the set specific consumer group and timely transmits the product information for the purchaser's reference, so as to achieve the communicative connection selling method with high uniqueness and effectiveness.

The shopping and marketing method of an item for specific consumers of the present invention further provides a sale assisting effect for the physical selling of a specific or non-general item, so that the method may be combined with a network to timely display related marketing information to compensate the deficiency of the selling in physical stores and achieve the network marketing features with specific targets and honor. In addition, the present invention also provides a network connection and message transmission channel between buyers and sellers, so that the buyer can sense the product, and the seller can transmitted the related network marketing information of the required item timely.

While the invention has been described by means of specific embodiments, numerous modifications and variations could be made thereto by those skilled in the art without departing from the scope and spirit of the invention set forth in the claims. In addition, the present invention complies with patent application requirements, and is thus duly filed for patent application.

What is claimed is:

1. A shopping and marketing method of an item for specific consumers, comprising:
(1) installing a networking module having an induction chip with at least one item ID onto an item body;
(2) sensing the item body by a mobile device connected to a marketing website, and transmitting the item ID to the marketing website;
(3) verifying the item ID after the marketing website receives the item ID; and
(4) connecting to a marketing webpage of a corresponding group if the item ID is matched, and displaying content and information of the marketing webpage on a display unit of the mobile device via a network.

2. The shopping and marketing method of an item for specific consumers according to claim 1, further comprising a step of setting at least a specific consumer group, and connecting and displaying the corresponding marketing webpage of the specific consumer group if the item ID is matched with the specific consumer groups.

3. The shopping and marketing method of an item for specific consumers according to claim 2, wherein the specific consumer group is categorized or selected according to the set item by a computer automatically.

4. The shopping and marketing method of an item for specific consumers according to claim 1, wherein the Step (3) automatically determines and verifies the item ID by a verifying content installed in a verification unit.

5. The shopping and marketing method of an item for specific consumers according to claim 2, wherein if the item ID is not matched with the specific consumer groups after verification, the display unit of the mobile device will not display any content or information.

6. The shopping and marketing method of an item for specific consumers according to claim 1, wherein the networking module is an electronic tag, NFC tag, or an assembly capable of performing an inductive networking, and the networking module further includes an induction coil.

7. The shopping and marketing method of an item for specific consumers according to claim 1, wherein the item body is an item of a product, a card or a tag.

8. The shopping and marketing method of an item for specific consumers according to claim 1, wherein the mobile device is a smart phone, a Tablet PC or a smart wearable device, and the mobile device includes a display unit, a control unit, an NFC reading unit, an input/output unit and a communication unit.

9. The shopping and marketing method of an item for specific consumers according to claim 4, wherein the verification unit has a verifying content for determining and verifying the verifying content of the item ID.

10. The shopping and marketing method of an item for specific consumers according to claim 1, wherein the marketing website is a cloud server.
